(19) United States
(12) Patent Application Publication
(10) Pub. No.: US 2008/0036702 A1
(43) Pub. Date: Feb. 14, 2008

(54) Plasma display apparatus

(75) Inventors: Kirack Park, Chilgok-gun (KR); Jongwoon Bae, Gumi-si (KR); Seonghwan Ryu, Gumi-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/607,989

(22) Filed: Dec. 4, 2006

(30) Foreign Application Priority Data
Aug. 9, 2006 (KR) 10-2006-0075428

(51) Int. Cl. G09G 3/28

(52) U.S. Cl. 345/67

(57) ABSTRACT

Disclosed are a plasma display apparatus. The plasma display apparatus, comprising: a plasma display panel comprising a plurality of electrodes; and a driver supplying a driving signal to a predetermined electrode of the plurality of electrodes, wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, and wherein a exhaust unit is omitted from the rear substrate, and the driver supplies a first reset signal to the first electrode in a reset period for initializing a first subfield and supplies a second reset signal to the first electrode in the reset period of a second subfield, a magnitude of a voltage of the second reset signal is different from that of first subfield.

### CROSS-REFERENCE TO RELATED APPLICATIONS

The present application claims priority from Korean Patent Application No. 10-2006-075428, filed in Korea on Aug. 9, 2006, the entire contents of each is incorporated herein by reference.

### BACKGROUND

1. Field of the Invention

This document relates to a plasma display apparatus.

2. Description of the Background Art

Usually, a plasma display apparatus includes a plasma display panel (PDP) on which a plurality of electrodes are formed, and a driver for supplying a predetermined driving signal to a driver.

The PDP includes a plurality of electrodes and a phosphor layer formed in a discharge cell between barrier ribs. The driver supplies the driving signal to the discharge cell through the electrodes. As a result thereof, the discharge cell is discharged by the driving signal.

Furthermore, when the discharge cell is discharged by the driving signal, the discharge gas filled in the discharge cell generates vacuum ultraviolet (UV) rays and enables the generated UV rays to emit light from the phosphor formed in the discharge cell so that visible rays are generated. These visible rays enable an image to be displayed on a screen of the PDP.

### SUMMARY OF THE INVENTION

Accordingly, the present invention has been made to solve the above-mentioned problems occurring in the prior art.

Additional advantages, objects and features of the invention will be set forth in part in the description which follows and in part will become apparent to those having ordinary skill in the art upon examination of the following or may be learned from practice of the invention.

According to an aspect of the present invention, there is provided a plasma display apparatus, comprising: a plasma display panel comprising a plurality of electrodes; and a driver supplying a driving signal to a predetermined electrode of the plurality of electrodes, wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, and wherein a exhaust unit is omitted from the rear substrate, and the driver supplies a first reset signal to the first electrode in a reset period for initializing a first subfield and supplies a second reset signal to the first electrode in the reset period of a second subfield, q magnitude of a voltage of the second reset signal is different from that of first subfield.

According to another aspect of the present invention, there is provided a plasma display apparatus, comprising: a plasma display panel comprising a plurality of electrodes; and a driver supplying a driving signal to a predetermined electrode of the plurality of electrodes, wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, and wherein a exhaust unit is omitted from the rear substrate, and the driver supplies a first number of reset signals to the first electrode in a reset period for initializing a first subfield and supplies a second number of reset signals to the first electrode in the reset period of a second subfield, a first number of the reset signals are different from a second number of the reset signals.

According to still another aspect of the present invention, there is provide a plasma display apparatus, comprising: a plasma display panel comprising a plurality of electrodes; and a driver supplying a driving signal to a predetermined electrode of the plurality of electrodes, wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, wherein a exhaust unit is omitted from the rear substrate, and the driver supplies a reset signal to the first electrode in a reset period of a first subfield, and wherein the driver does not supply the reset signal to the first electrode in a reset period for initializing a second subfield, or omits the reset period of the second subfield.

### BRIEF DESCRIPTION OF THE DRAWINGS

The above aspects of the present invention will be more apparent by describing certain exemplary embodiments of the present invention with reference to the accompanying drawings, in which:

FIG. 1 is a diagram illustrating the constitution of a plasma display apparatus according to an exemplary embodiment of the present invention;

FIGS. 2A to 2D are diagram illustrating an example of a plasma display panel in the plasma display apparatus according to the exemplary embodiment of the present invention;

FIG. 3 is a diagram for explaining an example of a manufacturing process of the plasma display panel in the plasma display apparatus according to the exemplary embodiment of the present invention;

FIG. 4 is a diagram for explaining a frame for implementing gradation of an image in the plasma display apparatus according to the exemplary embodiment of the present invention;

FIG. 5 is a diagram for explaining an example of an operation of the plasma display apparatus according to the exemplary embodiment of the present invention;

FIGS. 6A and 6B are a diagram for explaining other type of a rising ramp signal and a second falling ramp signal;

FIGS. 7A to 7F are a diagram for explaining the magnitude of a voltage of a reset signal;

FIGS. 8A to 8F are a diagram for explaining the number of reset signals;

FIG. 9 is a diagram for explaining a width of the reset signal;

FIGS. 10A to 10B are a diagram for explaining omission of the reset signal or the reset period;

FIG. 11 is a diagram for explaining other type of a sustain signal;

FIG. 12 is a diagram for explaining a single layer structure of first and second electrodes in a structure that a discharge tip is omitted;

FIG. 13 is a diagram for explaining an example of a structure that a black layer is added between the first and second electrodes and a front substrate; and

FIG. 14 is a diagram for explaining an example of the first and second electrodes of the plasma display panel according to the exemplary embodiment of the present invention.

### DETAILED DESCRIPTION

Hereinafter, exemplary embodiments of the present invention will be described in detail with reference to the accompanying drawings. The aspects and features of the present invention ad methods for achieving the aspects and features will be apparent by referring to the embodiments to be described in detail with reference to the accompanying drawings. However, the present invention is not limited to the embodiments disclosed hereinafter, but can be implemented in diverse forms.

The matters defined in the description, such as the detailed construction and elements, are nothing but specific details provided to assist those of ordinary skill in the art in a comprehensive understanding of the invention, and the present is only defined within the scope of the appended claims. In the entire description of the present invention, the same drawing reference numerals are used for the same elements across various figures.

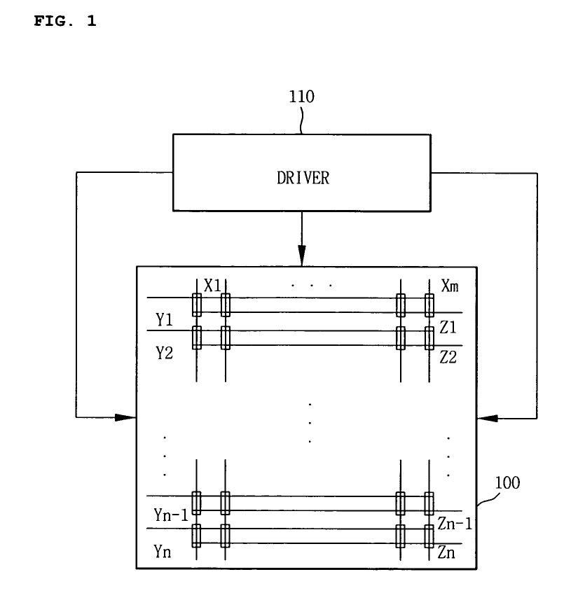

FIG. 1 is a diagram illustrating the constitution of a plasma display apparatus according to an exemplary embodiment of the present invention.

Referring to FIG. 1, the plasma display apparatus comprises a plasma display panel (PDP) 100 and a driver 110.

The driver 110 supplies a driving signal to a predetermined electrode of a plurality of electrodes.

Although FIG. 1 shows that the driver 110 is composed only of one board type, the driver 110 may be divided into a plurality of board types according to the electrodes formed in the plasma display panel.

For example, in the plasma display apparatus, if the plasma display panel 100 includes first and second electrodes that are in parallel to each other, and a third electrode where the first and second electrodes intersect, the driver 110 may be divided into a first driver (not shown) for driving the first electrode, a second driver (not shown) for driving the second electrode, and a third driver (not shown) for driving the third electrode.

The driver 110 of the plasma display apparatus will be later explained in more detail.

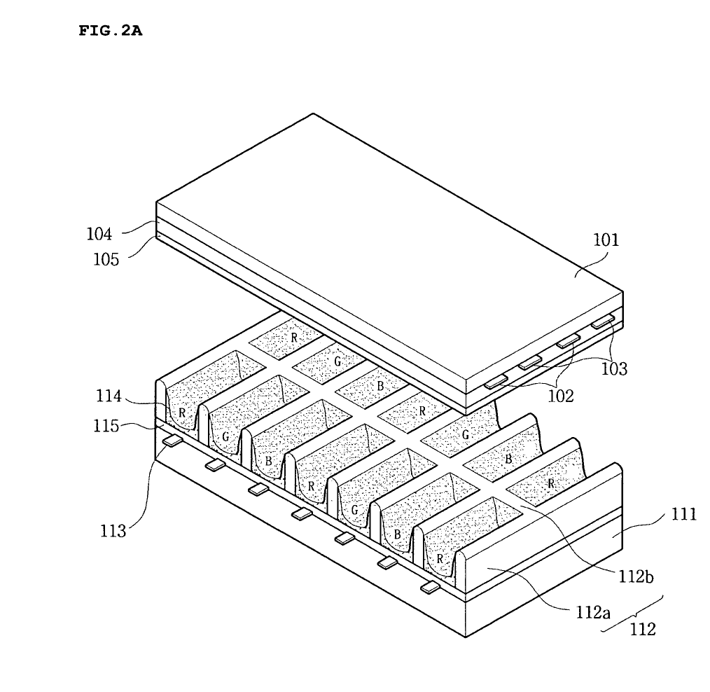

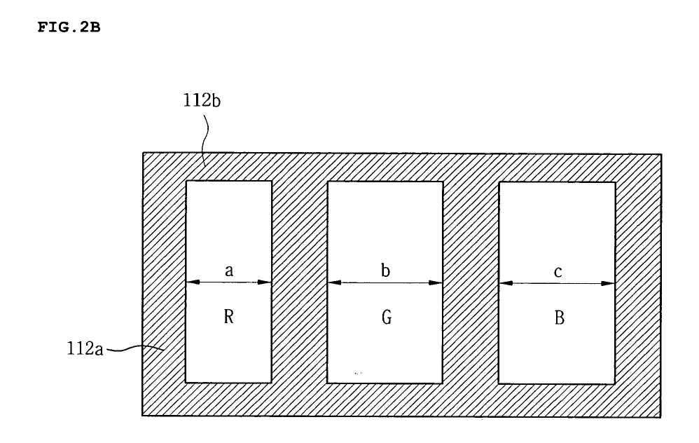

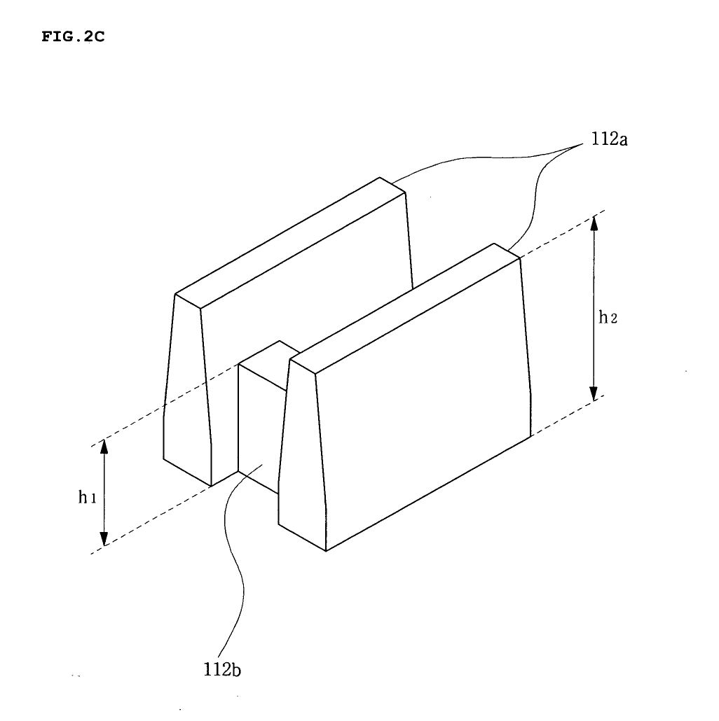

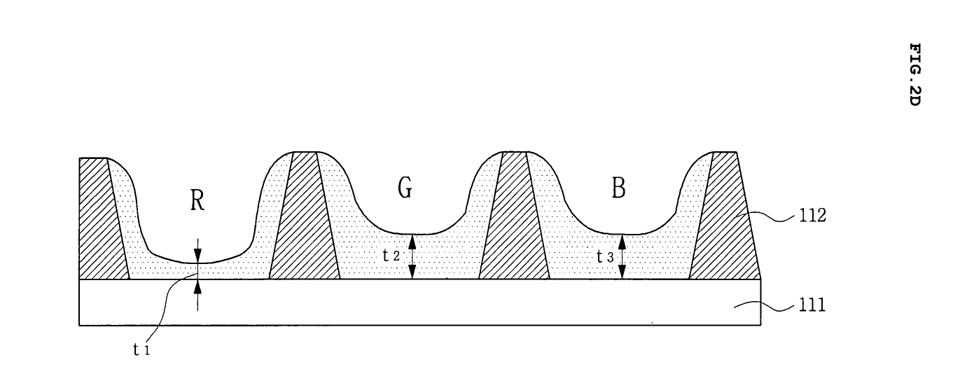

The plasma display panel 100 comprises a plurality of electrodes. An example of the plasma display panel 100 will be now explained in more detail with reference to FIGS. 2A to 2D.

FIGS. 2A to 2D are diagram illustrating an example of a plasma display panel in the plasma display apparatus according to the exemplary embodiment of the present invention.

Referring to FIG. 2A, the plasma display panel 100 includes a front substrate 101 and a rear substrate 111 that are spaced by a constant distance and combined to each other. The front substrate 101 includes a first electrode (Y) 102 and a second electrode (Z) 103 that are formed in parallel to each other. The rear substrate 111 includes a third electrode (X) where the first and second electrodes 102 and 103 intersect.

The first and second electrodes 102 and 103 may be respectively formed of a single layer. For example, the first and second electrodes 102 and 103 are respectively an electrode (ITO-Less) where a transparent electrode is omitted.

At least one of the first and second electrodes 102 and 103 may have a darker color than a upper dielectric layer 104. The upper dielectric layer 104 will be explained in detail below.

A exhaust unit is omitted from the rear substrate 111. The exhaust unit may be also omitted from the front substrate 101 and rear substrate 101 respectively. The exhaust unit may be at least one of a exhaust hole, an exhaust tip and an exhaust pipe. This will be explained in detail below.

The electrodes formed on the front substrate 101, e.g., the first and second electrodes 102 and 103 can discharge a discharge space (i.e., discharge cell) and sustain the discharge cell.

The upper dielectric layer 104 may be formed on an upper part of the front substrate 101, on which the first and second electrodes 102 and 103 are formed, to cover the first and second electrodes 102 and 103.

The upper dielectric layer 104 limits the discharge current of the first and second electrodes 102 and 103 and isolates between the first and second electrodes 102 and 103.

A prevention layer 105 may be formed on a upper surface of the upper dielectric layer 104. The prevention layer 105 may be formed by depositing a material such as MgO on the upper dielectric layer 104.

A third electrode 113 is formed on the rear substrate 111. A lower dielectric layer 115 may be formed on the rear substrate 111, on which the third electrode 113 is formed, to cover the third electrode 113.

The lower dielectric layer 115 can isolate the third electrode 113.

A barrier rib 112 may be formed on the lower dielectric layer 115 to divide the discharge cell. The barrier rib 112 is configured of a stripe type, a well type, a delta type, a honeycomb type, and others. Accordingly, the discharge cells, such as a red (R) discharge cell, a green (G) discharge cell, and a blue (B) discharge cell, may be formed between the front substrate 101 and the rear substrate 111.

A white (W) discharge cell and a yellow (Y) discharge cell, except R, G, and B discharge cells, may be formed between the front substrate 101 and the rear substrate 111.

Pitches of the R, G, and B discharge cells are substantially the same. However, pitches of the R, G, and R discharge cells may be differently set to match each color temperature in the R, G, and B discharge cells, as shown in FIG. 2B.

In this case, all pitches of each of the R, G, and B discharge cells may be differently set, or the pitch of at least one of the R, G, and B discharge cells may be set to be different from that of the other discharge cells. In other words, as shown in FIG. 2B, a pitch (a) of the R discharge cell is the smallest, pitches (b, c) of the G and B discharge cells may be greater than the pitch (a) of the R discharge cell.

The pitch (b) of the G discharge cell may be substantially the same or different from the pitch (c) of the B discharge cell.

In the plasma display apparatus according to the present invention, the plasma display panel may be made of a structure of the barrier rib 112 shown in FIG. 2A as well as a structure of the barrier rib having various shapes. For example, the barrier rib 112 includes first and second barrier ribs 112a and 112b. The barrier rib 112 may be made of a difference type barrier rib structure that a height of a first barrier rib 112b is different from that of a second barrier rib 112a, a channel type barrier rib structure that a channel available to an exhaust passage is formed in one of the first and second barrier ribs 112a and 112b, and a hollow type barrier rib structure that a hollow is formed on one or more of the first and second barrier ribs 112a and 112b.

As shown in FIG. 2C, if the barrier rib 112 is the difference type barrier rib structure, the height (h1) of the first barrier rib 112b may be lower than the height (h2) of the second barrier rib 112a. Further, if the barrier rib 112 is the channel type barrier rib structure or hollow type barrier rib structure, the channel or hollow may be formed in the first barrier rib 112b.

In the plasma display panel according to the exemplary embodiment of the present invention, even through each of the R, G and B discharge cells is aligned on the same line, each of the R, G and B discharge cells may be aligned to different shapes. For example, each of the R, G and B discharge cells may be aligned to the delta type of a triangle shape. A shape of each discharge cell may have various polygonal shapes such as a quadrangle, a pentagon, a hexagon.

A desired discharge gas such as argon (Ar) and xenon (Xe) is filled in the discharge cells that are divided by the barrier rib 112.

A phosphor layer 114 is formed in the discharge cells, which are divided by the barrier rib 112, to emit visible rays for displaying the image during an address discharge. For example, a red (R) phosphor layer, a green (G) phosphor layer and a blue (B) phosphor layer may be formed.

Further, a white (W) phosphor layer and a yellow (Y) phosphor layer, except the red (R) phosphor layer, the green (G) phosphor layer and the blue (B) phosphor layer, may be formed in the discharge cells that are divided by the barrier rib 112.

The thickness of the phosphor layer 114 of the R, G and B discharge cells can be substantially either the same or different from. For example, when the thickness of the phosphor layer 114 in at least one of the R, G and B discharge cells is different from that of the phosphor layer 114 in other discharge cells, the thickness (t2, t3) of the phosphor layer 114 in the G and B discharge cells may be thicker than the thickness (t1) of the phosphor layer 114 in the R discharge cell. The thickness (t2) of the phosphor layer 114 in the G discharge may be substantially the same as or different from the thickness (t3) of the phosphor layer 114 in the B discharge cell.

As described above, only an example of the plasma display panel in the plasma display apparatus is explained, but not limited thereto. For example, the upper dielectric layer 104 and lower dielectric layer 115 are respectively composed of one layer, but one or all of the upper dielectric layer 104 and lower dielectric layer 115 may be composed of a plurality of layers.

The barrier rib 112 may further form a black layer (not shown) on the upper part of the barrier rib 112 to absorb light supplied from the outside source.

The black layer (not shown) may further formed at a specific location on the front substrate 101 that corresponds to the barrier rib 112.

The third electrode 113 formed on the rear substrate 111 may have a constant width or thickness, but the width or thickness inside the discharge cell may be different from that outside the discharge cell. For example, the width or thickness inside the discharge cell of the third electrode 113 may be wider or thicker than that outside the discharge cell.

As such, the structure of the plasma display panel in the plasma display apparatus can be variously changed.

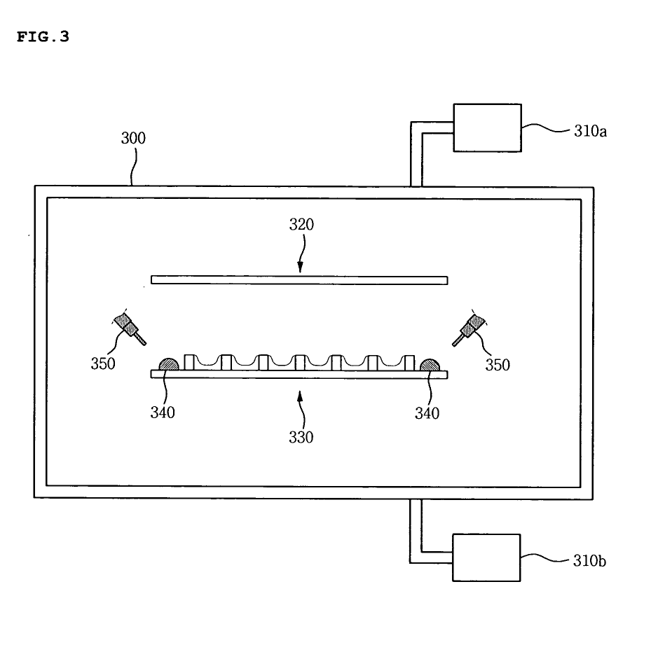

FIG. 3 is a diagram illustrating an example of a manufacturing process of the plasma display panel in the plasma display apparatus according to the exemplary embodiment of the present invention.

Referring to FIG. 3, a front substrate 320 and a rear substrate 330 are aligned in a chamber 300. An exhaust port 310a exhausts gases within the chamber 300. A gas injection port 310b injects discharge gas into the chamber 300. A calcination unit 350 calcines a seal layer 340.

After performing a predetermined manufacturing process, the front substrate 320 and the rear substrate 330 may be aligned within the chamber 300.

The seal layer 340 may be formed on a part of the front substrate 320 and/or the rear substrate 330 to seal them to each other. For example, the seal layer 340 may be formed on the rear substrate 330.

The exhaust port 310a exhausts gases within the chamber 300 in which the front substrate 320 and rear substrate 330 are aligned. In other words, the exhaust port 310a exhausts impurity gases within the chamber 300 to the outside.

As a result thereof, the gas injection port 310b can inject the discharge gas into the chamber 300. The gas injection port 310b can inject the discharge gas such as the xenon (Xe), neon (Ne) and argon (Ar), so that a pressure of the chamber 300 becomes more than approximately 4×10⁻² torr and less than 2 torr, in an atmosphere that temperature within the chamber 300 is more than approximately 200° C. and less than 400° C.

Next, the front substrate 320 and the rear substrate 330 may be sealed to each other using a predetermined sealing method (not shown). The calcination unit 350 radiates heat or light to harden the seal layer 340, so that the front and rear substrates 320 and 330 is severely sealed.

The seal layer 340 may include photo-hardenable material. The photo-hardenable material comprise epoxy-based material harden by ultraviolet ray. Accordingly, when the front substrate 320 and rear substrate 330 are sealed, the calcination unit 350 can harden and calcine the seal layer 340 by radiating the light, i.e., ultraviolet ray on the seal layer 340. As a result thereof, the generation of the impurity gases can be prevented.

As described above, if the plasma display panel is formed by sealing the front substrate 320 on the rear substrate 330, the discharge gas can be injected into the discharge cell during the sealing process. Accordingly, there is not a need to form the exhaust hole on the front substrate 320 and rear substrate 330, thereby allowing the exhaust hole to be omitted.

As such, the exhaust hole is omitted, and thus a conventional exhaust tip for connecting the gas injection port for injecting the discharge gas through the exhaust hole is also omitted. The exhaust tip may be analyzed as an exhaust pipe.

Conventionally, when the impurity gas inside the plasma display panel is exhausted and the discharge gas is injected, using the exhaust tip, there is a storing probability that the impurity gas remains inside the plasma display panel (i.e., discharge cell), because the exhaust tip is only formed at a specific location on the plasma display panel and the exhaust process and gas injection process are performed after sealing the front substrate and the rear substrate. Accordingly, the conventional exhaust tip prevents the impurity gas to be discharged, thereby allowing a discharge voltage to be more increased, allowing the discharge to be instable due to the exhaust variation. Consequently, a driving efficiency may be reduced.

On the other hand, as shown in FIG. 3, if the exhaust and gas injection are simultaneously performed during the sealing process, the impurity gas can be sufficiently removed and also the discharge gas can uniformly injected.

Accordingly, the plasma display panel having the Tip-Less structure without the exhaust tip can stably generate the discharge, compared with the plasma display panel having the conventional exhaust tip, even when the driving voltage is relatively lowered.

Further, the plasma display panel having the conventional exhaust tip has to be performed in order of the sealing process, a coupling process of the exhaust tip, the exhaust process, and the gas injection process.

On the other hand, since the plasma display panel having the Tip-Less structure simultaneously performs the exhaust and gas injection processes during the sealing process, the number of the manufacturing process can be greatly reduced and thus the processing time can be shorten.

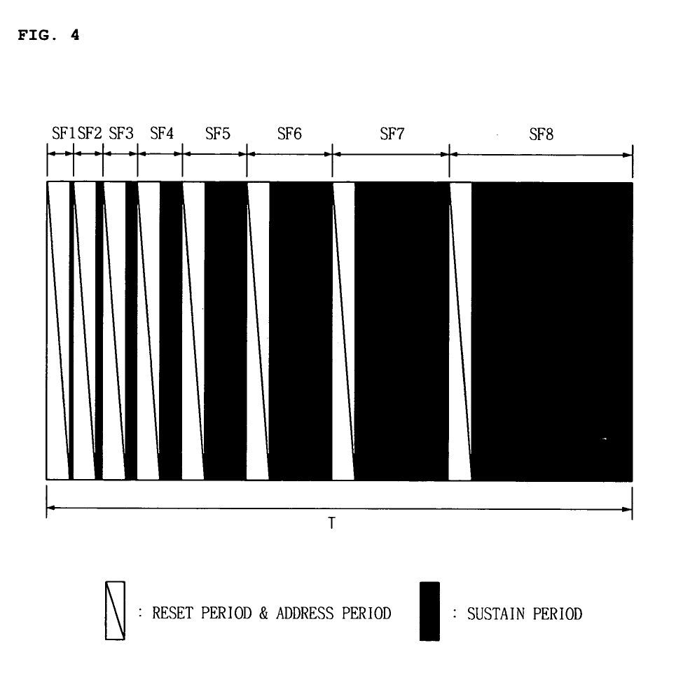

FIG. 4 is a diagram for explaining a frame for implementing the gray scale of an image in the plasma display apparatus according to the exemplary embodiment of the present invention.

FIG. 5 is a diagram for explaining an example of an operation of the plasma display apparatus according to the exemplary embodiment of the present invention.

First, referring to FIG. 4, the frame for implementing the gray scale in the plasma display apparatus may be divided into a plurality of subfields, the number of emission of each subfield being different from each other.

Although not shown in the drawings, at least one subfield may be divided into a reset period for initialing all discharge cells, an address period for selecting the discharge cell to be discharged, and a sustain period for implementing the gray scale depending on the number of the emissions.

For example, when the image is displayed with 256 gray scales, one frame is divided into eight subfields (SF1 . . . SF8). At least one of the eight subfields (SF1 . . . SF8) is again divided into the reset period, the address period and the sustain period.

Meanwhile, by controlling the number of the sustain signals that are supplied in the sustain period, a gray scale weight of a corresponding subfield can be set. In other words, the gray scale weight can give to each subfield in the sustain period. For example, by setting the gray scale weight of a first subfield to 2⁰, and the gray scale weight of a second subfield to 2¹, the gray scale weight of each subfield can be determined so as to be increased in the ratio of 2n (n=0, 1, 2, 3, 4, 5, 6, 7). As such, the number of the sustain signals, which are supplied in the sustain period of each subfield, is controlled according to the gray scale weight in each subfield, thereby allowing the various gray scales of the image to be implemented.

According to the present invention, the plasma display apparatus uses a plurality of frames to implement the image, for example, to display the image for a second. In other words, 60 numbers of the frames are used to display the image for a second. In this case, the length (T) of the frame is 1/60 seconds, i.e., 16.67 milliseconds.

Although FIG. 4 shows and explains that one frame includes eight subfields, the number of the subfields can be variously changed. For example, one frame may be configured of twelve subfields or ten subfields.

Although FIG. 4 shows that the subfields are aligned in such an order that the size of the gray scale weight is increased in one frame, the subfields in one frame may be aligned in such an order that the gray scale weight is decreased, or aligned irrespective of the gray scale weight.

Referring to FIG. 5, it is exemplified that the plasma display apparatus according to the prevent invention is operated in one of the subfields included in one frame.

First, a first falling ramp (Ramp-Down) signal may be supplied to a first electrode (Y) by the driver (110) in a pre-reset period prior to a reset period. All driving signals to be explained below are to be supplied by the driver (110).

When the first falling lamp signal is supplied to the first electrode (Y), a pre-sustain signal with a polarity opposite to the first falling lamp signal may be supplied to a second electrode (Z).

The falling lamp signal supplied to the first electrode (Y) can gradually fall up to a tenth voltage (V10).

A pre-sustain signal can substantially and constantly maintain a pre-sustain voltage (Vpz). The pre-sustain voltage (Vpz) may be approximately equal to a voltage of a sustain signal (SUS) supplied in later sustain period, i.e., a sustain voltage (Vs).

As such, when, during the pre-reset period, the first falling lamp signal is supplied to the first electrode (Y) and the pre-sustain signal is supplied to the second electrode (Z), wall charges of a predetermined polarity are accumulated on the first electrode (Y) and wall charges of a polarity opposite to the first electrode (Y) are accumulated on the second electrode (Z). For example, positive (+) wall charges are accumulated on the first electrode (Y) and negative (−) wall charges are accumulated on the second electrode (Z).

As a result thereof, sufficient intensity of a set-up discharge can be caused in later reset period, thereby allowing the initialization to be stably performed.

Further, even when the voltage of the rising ramp signal (Ramp-Up) supplied to the first electrode (Y) in the reset period becomes smaller, the sufficient intensity of the set-up discharge can be caused.

In order to secure the driving time, the pre-reset period is included prior to the reset period in the subfield, which is firstly aligned, among subfields of the frame, or in two or three subfields among the subfields of the frame.

This pre-reset period may be omitted in all of the subfields.

After the pre-reset period, the reset signal is supplied to the first electrode (Y) in the reset period for the initialization. The reset signal may include the rising ramp signal (Ramp-Up) and falling ramp signal (Ramp-Down).

For example, a first falling ramp signal and the rising ramp signal (Ramp-Up) having a polarity opposite to the first falling ramp signal may be supplied in the setup (Set-Up) period.

The rising ramp signal includes a first rising ramp signal and a second rising ramp signal. The first rising ramp signal gradually rises from a 20-th voltage (V20) to a 30-th voltage (V30) by a first gradient. The second rising ramp signal rises from the 30-th voltage (V30) to a 40-th voltage (V40) by a second gradient.

For the set-up period, a weaker dark discharge (i.e., setup discharge) is caused within the discharge cell by the rising ramp signal. The setup discharge causes the wall charges to be accumulated.

The second gradient of the second rising ramp signal can be lower than the first gradient. If so, the voltage is rapidly increased until before the setup discharge is generated, while the voltage is slowly increased during the generation of the setup discharge. Accordingly, an amount of the light, which is generated by the setup discharge, can be decreased. As a result thereof, contrast characteristics of the image can be improved.

In a set-down period after the setup period, a second falling ramp signal (Ramp-Down) is supplied to the first electrode (Y) with a polarity opposite to the rising ramp signal after the rising ramp signal.

The second falling ramp signal can be gradually fallen from the 20-th voltage (V20) to a 50-th voltage (V50).

Accordingly, a weaker erase discharge (i.e., set-down discharge) occurs within the discharge cell. The set-down discharge causes the wall charges to remain uniformly in the discharge cell, where the number of the wall charges is the extent that the address discharge can stably occur.

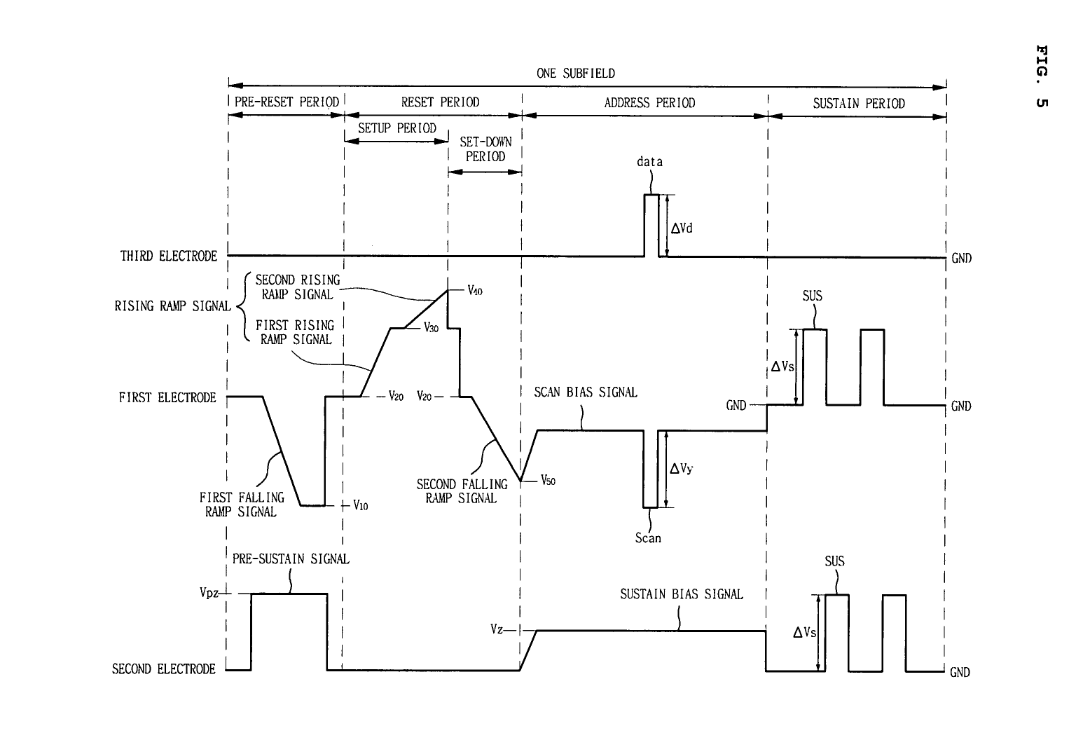

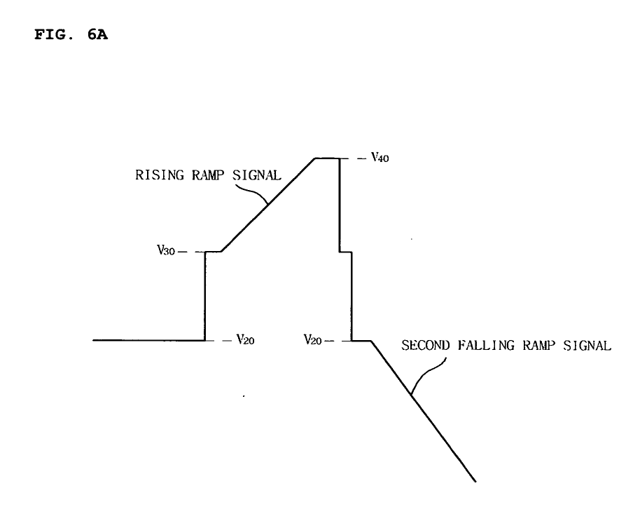

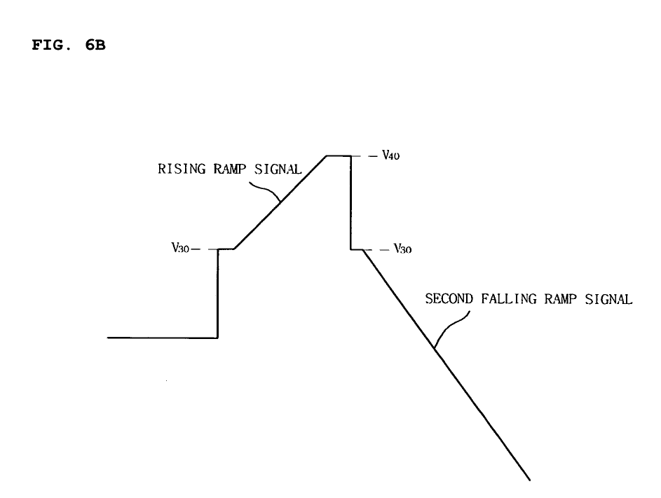

FIGS. 6A and 6B are a diagram for explaining other type of a rising ramp signal and a second falling ramp signal.

Referring to FIG. 6A, the rising ramp signal rapidly rises up to the 30-th voltage (V30) and then gradually rises from the 30-th voltage (V30) to the 40-th voltage (V40).

As such, the rising ramp signal can be gradually raised by two gradients different from each other, as shown in FIG. 5. The rising ramp signal can be also gradually raised by one gradient. This can be changed by various forms.

Referring to FIG. 6B, the second falling signal is fallen gradually from the 30-th voltage (V30).

The second falling ramp signal can differently change a point of time when the voltage falls, and be changed to various forms.

As described above, in the plasma display panel without the exhaust tip according to the present invention, the size of the driving voltage may be lower than the conventional plasma display panel having the exhaust tip, because the discharge gases are equally distributed within the panel.

For example, in the conventional plasma display panel including the exhaust tip, the possibility that the impurity gas is contained in the discharge gas within the discharge cell is higher, thereby allowing the driving voltage to be increased by the impurity gas.

On the other hand, in the plasma display panel without the exhaust tip, the discharge gases are equally distributed within the discharge cell, and the impurity gas is smaller than the convent plasma display panel having the exhaust tip. Accordingly, the discharge can occur at a very lower voltage.

The voltage of the reset signal of the plasma display panel according to the present invention may be lower than that of the conventional plasma display panel. The voltage of the reset signal of at least one of the subfields may be set to be lower than that of the other subfields.

Further, the number of the reset signals in at least one subfield of the subfields may be set to be lower than that of the other subfields.

Further, the width of the reset signals in at least one subfield of the subfields may be set to be lower than that of the other subfields.

Further, the reset signals do not supplied in the reset period in at least one subfield of the subfields or can omit the reset period.

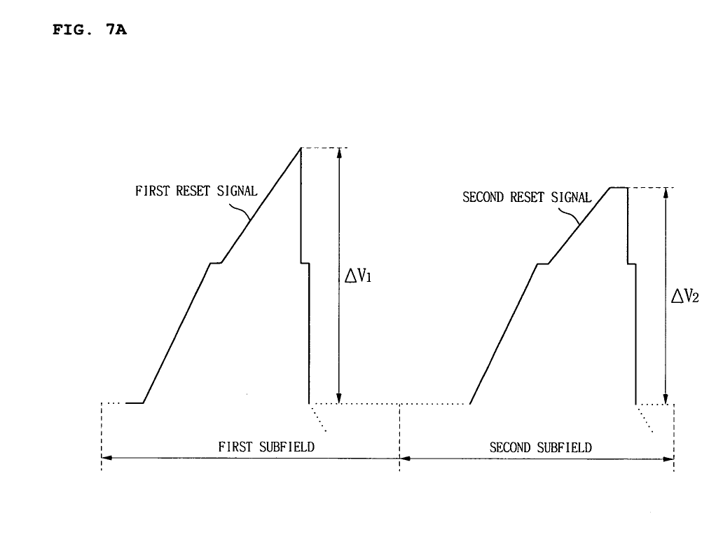

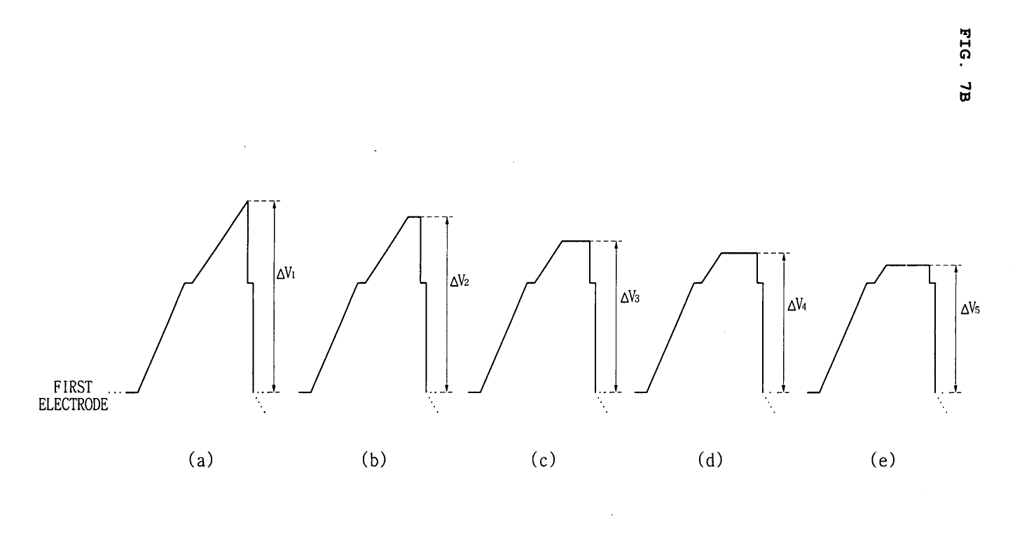

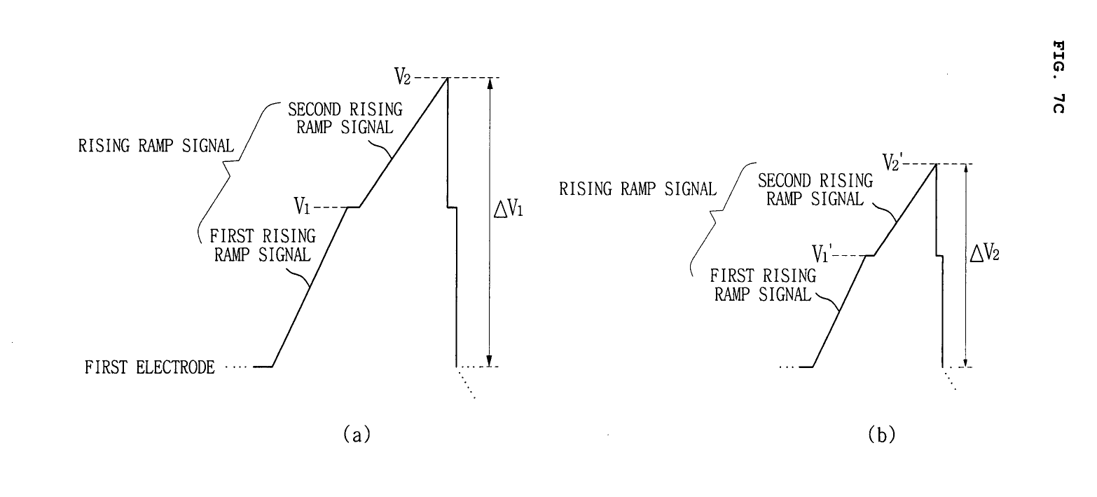

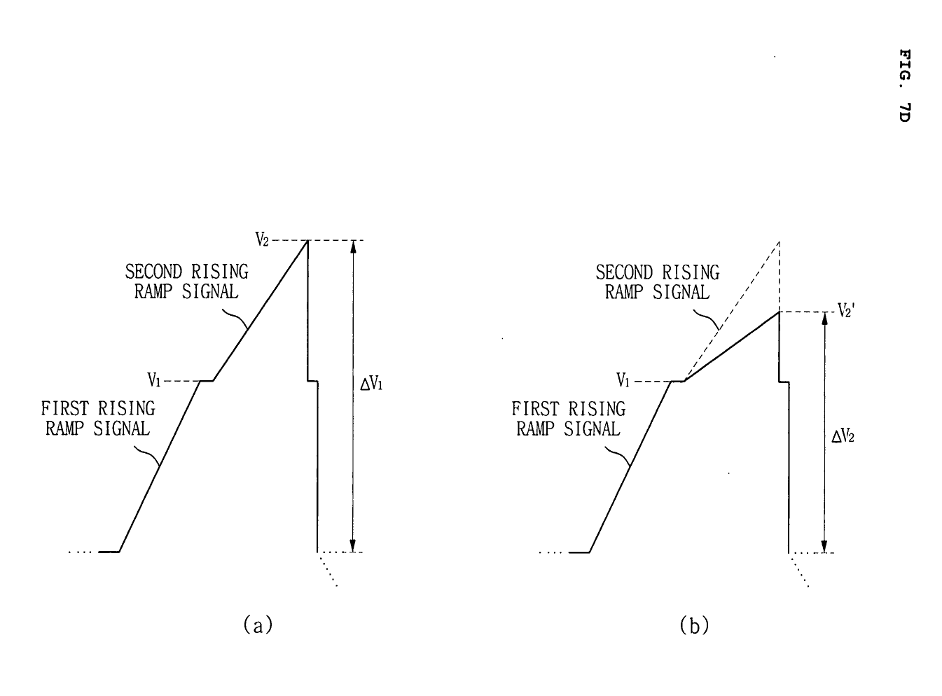

FIGS. 7A to 7F are a diagram for explaining the magnitude of a voltage of a reset signal.

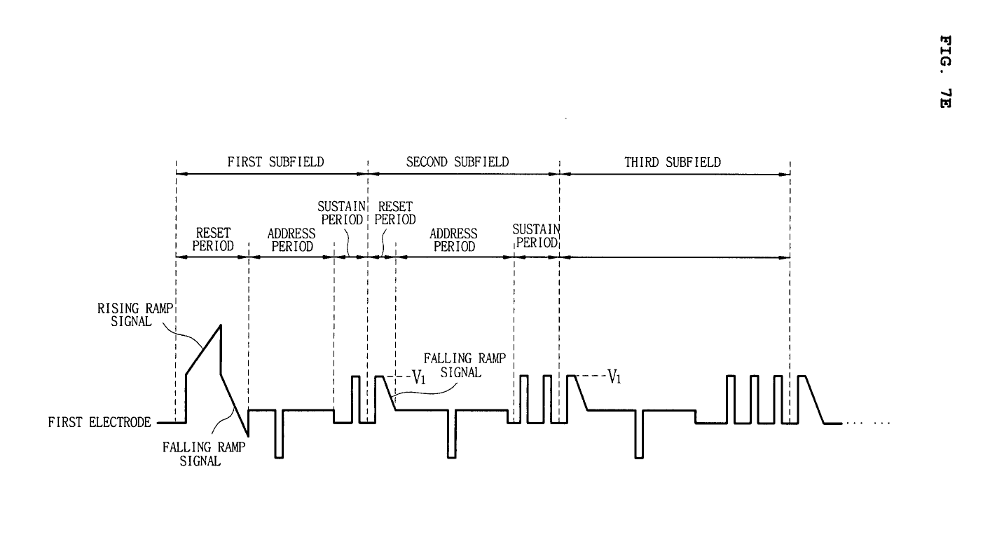

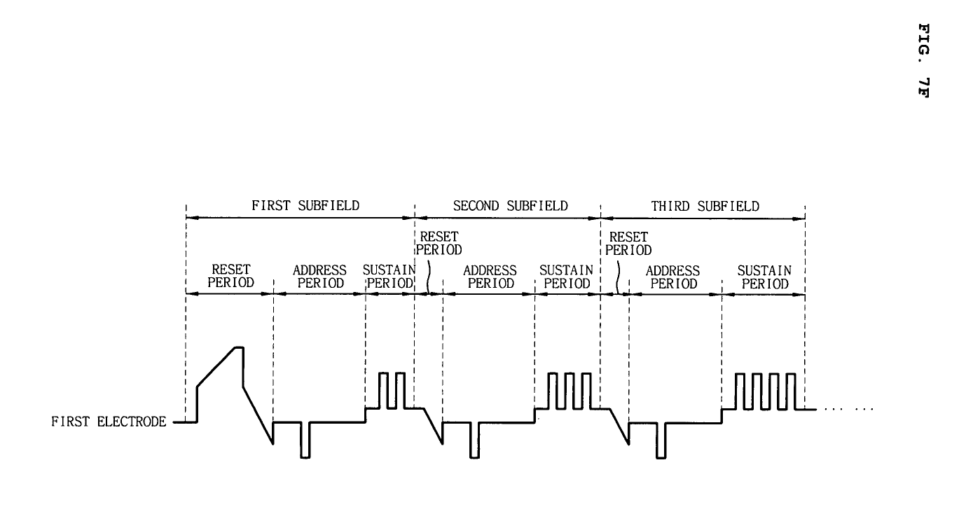

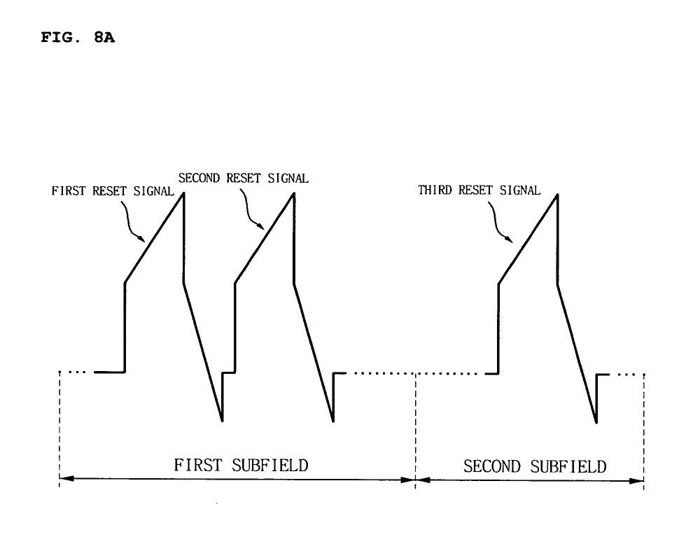

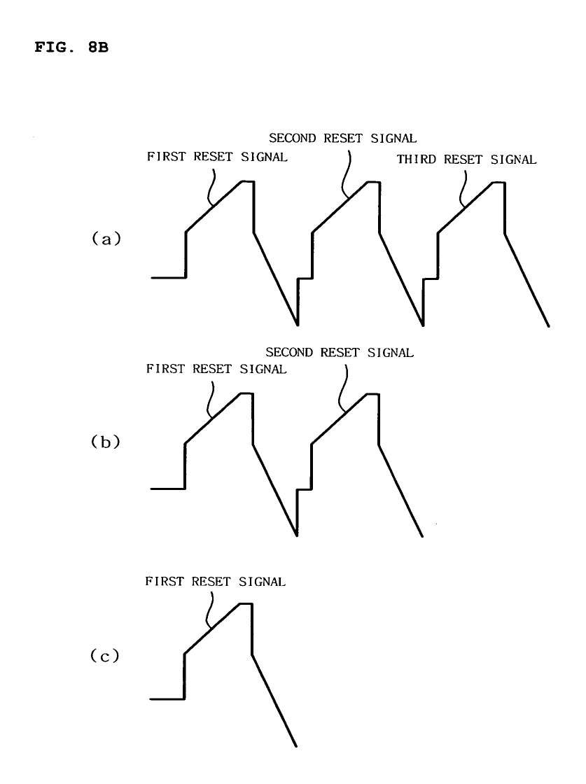

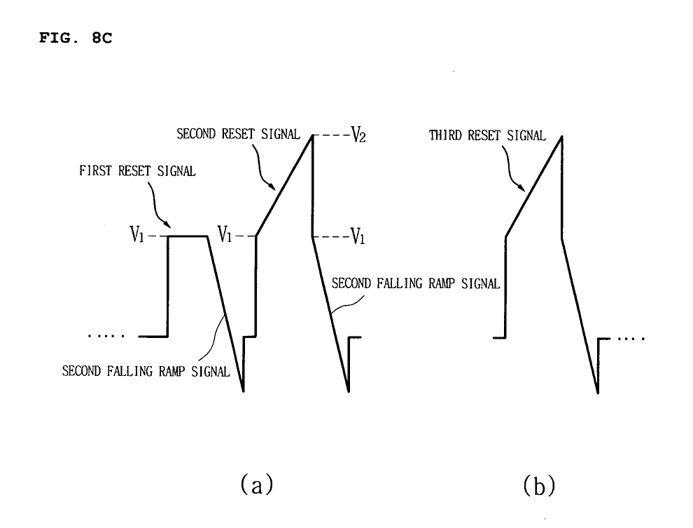

FIGS. 8A to 8F are a diagram for explaining the number of reset signals.

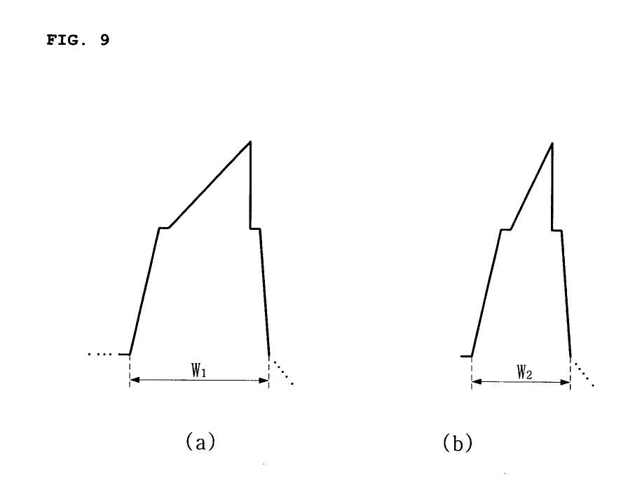

FIG. 9 is a diagram for explaining a width of the reset signal.

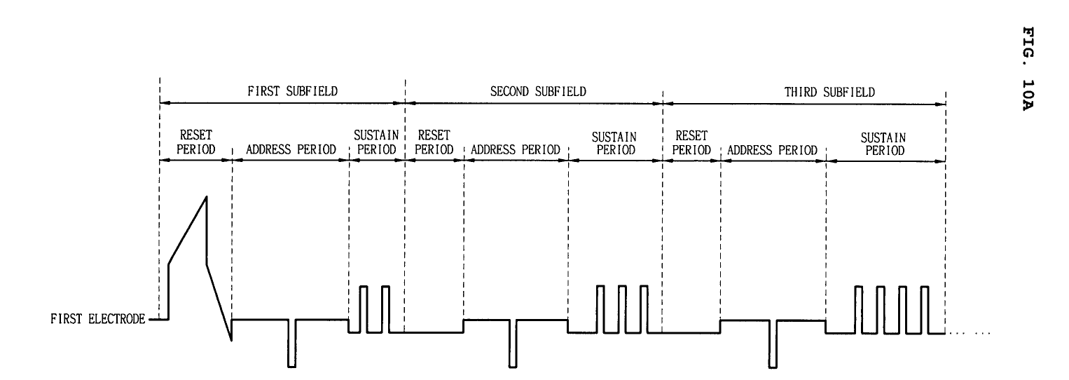

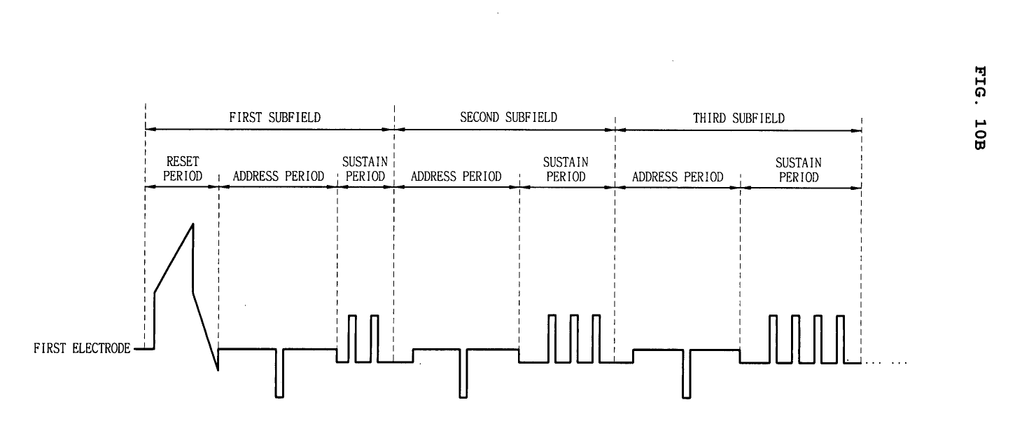

FIGS. 10A to 10B are a diagram for explaining omission of the reset signal or the reset period.

Referring to FIG. 7A, the magnitude of a voltage (ΔV1) of a first reset signal, which is supplied to the first electrode in the reset period for initializing a first subfield, is different from the magnitude of a voltage (ΔV2) of a second reset signal which is supplied to the first electrode in the reset period of a second subfield.

If the gray scale weight of the first subfield is less than that of the second subfield, the magnitude of the voltage (ΔV1) of the first reset signal can be greater than the magnitude of the voltage (ΔV2) of the second reset signal.

Although the magnitude of the voltage of the reset signal in at least one of the plurality of the subfields is less than that of the other subfields, the reset discharge in the plasma display panel without the exhaust tip according to the present invention can stably occur. In the subfield with the large gray scale weight, the number of the sustain signals supplied in the sustain period is relatively larger. Accordingly, even when the magnitude of the voltage of the reset signal in the subfield with the large gray scale weight is less than that in the subfield with small gray scale weight, the reset discharge can be sufficiently stabilized.

If the magnitude of the voltage of the reset signal in at least one of the plurality of the subfields becomes less than that of the other subfields, the amount of the light, which occurs in the reset period, can be decreased, thereby allowing the contrast characteristics of the image to be improved.

FIG. 7B shows how to control the magnitude of the voltage of the reset signal with respect to the gray scale weight of the subfield.

For example, if a subfield (a) has the lowest gray scale weight, the magnitude of the voltage of the reset signal is ΔV1, if the gray scale weight of the subfield (b) is greater than that of the subfield (a), the magnitude of the voltage of the reset signal is ΔV2 less than ΔV1, if the gray scale weight of the subfield (c) is greater than that of the subfield (b), the magnitude of the voltage of the reset signal is ΔV3 less than ΔV2, if the gray scale weight of the subfield (d) is greater than that of the subfield (c), the magnitude of the voltage of the reset signal is ΔV4 less than ΔV3, and if the gray scale weight of the subfield (e) is greater than that of the subfield (f), the magnitude of the voltage of the reset signal is ΔV5 less than ΔV4.

Referring to FIG. 7C, if a start point or an end point of the rising ramp signal is controlled, the magnitude of the voltage of the reset signal may be differently controlled.

For example, in case of the subfield (a), the first rising ramp signal rises with the first gradient up to the first voltage (V1), and then the second rising ramp signal can rise with the second gradient different from the first gradient from the first voltage (V1) to the second voltage (V2). Thus, the magnitude of the voltage of the reset signal can be set to be V1.

On the other hand, in a case where the gray scale weight of the subfield (a) is higher than that of the subfield (b), the first rising ramp signal rises with the first gradient up to the first voltage (V1′) that is lower than the first voltage (V1), and then the second rising ramp signal can rise with the second gradient different from the first gradient from the first voltage (V1′) to the second voltage (V2′) that is lower than the first voltage (V1′). Thus, the magnitude of the voltage of the reset signal can be set to be ΔV2 that is lower than ΔV1.

In case of the gradient (b), the magnitude of the voltage of the reset signal can be set to be lower than the gradient (a).

Referring to FIG. 7D, if the gradient of the rising ramp signal is controlled, the magnitude of the voltage of the reset signal can be differently controlled.

For example, in a case of the subfield (a), the first rising ramp signal rises with the first gradient up to the first voltage (V1), and then the second rising ramp signal can rise with the second gradient different from the first gradient from the first voltage (V1) to the second voltage (V2). Thus, the magnitude of the voltage of the reset signal can be set to be ΔV1.

On the other hand, in the subfield (b), the first rising ramp signal rises with the first gradient up to the first voltage (V1), and then the second rising ramp signal can rise with the second′ gradient slower than the second gradient. Thus, the magnitude of the voltage of the reset signal can be set to be ΔV2 that is less than ΔV1.

Referring to FIG. 7C, the magnitude of the voltage of the reset signal can be differently controlled by selectively omitting the rising ramp signal.

For example, in case of the first subfield with low gray scale weight, the reset signal includes the rising ramp signal and the falling ramp signal. In case of the second and third subfield with the gray scale weight that is higher than the first subfield, the reset signal omits the rising ramp signal and can includes only falling ramp signal.

As shown in FIGS. 7A to 7F, the magnitude of the voltage of the reset signal can be controlled by various methods.

Referring to FIG. 8A, the number of the reset signals, which is supplied to the first electrode in the reset period for initializing the first subfield, may be different from that of the reset signal which is supplied to the first electrode in the reset period of the second subfield. This will be explained in detail with reference to FIGS. 8A to 8C.

If the gray scale weight of the first subfield is smaller than that of the second subfield, the number of the reset signals in the first subfield may be greater than that in the second subfield. For example, the number of the reset signals in the first subfields is 2, and the number of the reset signals in the second subfields is 1.

Referring to FIG. 8B, in case of the subfield (a) with low gray scale weight, first, second and third reset signals are supplied to the first electrode in the reset period. In case of the subfield (b) with the gray scale weight that is higher than the subfield (a), the number of the reset signals is “2” that is smaller than the subfield (a). In case of the subfield (c) with the gray scale weight that is higher than the subfield (b), the number of the reset signals is “1” that is smaller than the subfields (a) and (b).

Referring to FIG. 8C, in case of the subfield (a) with low gray scale weight, the first and second reset signals are supplied to the first electrode in the reset period. In case of the subfield (b) with the gray scale weight that is higher than the subfield (a), the number of the reset signals can be set to be “1” that is smaller than the subfield (a) The first reset signal may be different from the second reset signal.

For example, the first reset signal is a type where the rising ramp signal is omitted. The second reset signal is a type that includes the rising ramp signal and the falling ramp signal.

As shown in FIGS. 8A to 8C, the number of the reset signals can be variously changed.

Referring to FIG. 9, a pulse width (W1) of the reset signal, which is supplied to the first electrode in the reset period for initializing the first subfield, may be different from a pulse width (W2) that is supplied to the first electrode in the reset period of the second subfield. Its detail explanation will be omitted in FIG. 9.

If the gray scale weight of the first subfield is smaller than that of the second subfield, the pulse width (W1) of the reset signal in the first subfield can be higher than the pulse width (W2) of the reset signal in the second subfield.

As such, even when the pulse width of the reset signal in the reset period of at least one of the plurality of the subfields is smaller than the other subfields, the plasma display panel without the exhaust tip according to the present invention can stably produce the reset discharge, because the impurity gas content is low and the discharge gas is uniform. Consequently, the light occurring in the reset period is decreased, thereby allowing the contrast characteristics to be improved.

Referring to FIG. 10A, in the first subfield with a relatively low gray scale weight, the reset signal in the reset period is supplied to the first electrode. In the second and third subfields with the higher gray scale weight than the first subfield, the reset signal may not be supplied.

Referring to FIG. 10B, in the first subfield with a relatively low gray scale weight, the reset signal in the reset period is supplied to the first electrode. In the second and third subfields with the higher gray scale weight than the first subfield, the reset period can be omitted.

Au such, even when, in the reset period of at least one of the plurality of the subfields, the reset signal is not supplied or the reset period is omitted, the plasma display panel without the exhaust tip according to the present invention can stably produce the reset discharge, because the impurity gas content is low and the discharge gas is uniform. Consequently, the light occurring in the reset period is decreased, thereby allowing the contrast characteristics to be improved.

Meanwhile, in an address period after the reset period, a scan bias signal may be supplied to the first electrode (Y), where the scan bias signal substantially maintains a higher voltage than 50-th voltage (V50) of the second falling ramp signal, as shown in FIG. 5.

Further, a scan signal may be supplied to all of the first electrodes (Y1˜Yn), where the scan signal is fallen by a scan voltage (ΔVy) from the scan bias signal.

For example, the first electrode (Y1) is supplied with a first scan signal (Scan 1), the first electrode (Y2) is supplied with a second scan signal (Scan 2), and the first electrode (Yn) is supplied with an n-th scan signal (Scan n).

Meanwhile, a width of the scan signal may be changed in a subfield unit. In other words, the width of the scan signal in at least one subfield may be different from that of the scan signal in the other subfields. For example, the width of the scan signal, which is located on later time, may be smaller than that of the scan signal that is located on earlier time. The width of the scan signal according to an array sequence of the subfields may be decreased in order of 2.6 μs, 2.3 μs, 2.1 μs, 1.9 μs, and others, and also in order of 2.6 μs, 2.3 μs, 2.3 μs, 2.1 μs, 1.9 μs, 1.9 μs, and others.

As such, when the scan signal is supplied to the first electrode (Y), a data signal, which is raised by the magnitude of a data voltage (ΔVd) to be corresponded to the scan signal, may be supplied to a third electrode (X).

As the scan signal and data signal are supplied to the third electrode (X), a voltage difference between the voltage of the scan signal and a data voltage (Vd) of the data signal is added to a wall voltage caused by the wall charges created in the reset period. Consequently, the address discharge occurs within the discharge cell that is supplied with the voltage (Vd) of the data signal.

A sustain bias signal is supplied to the second electrode (Z) in order to prevent the address discharge from being instable due to interference of the second electrode (Z) in the address period.

The sustain bias signal can substantially and constantly maintain a sustain bias voltage (Vz) that is smaller than the voltage of the sustain signal supplied in the sustain period and higher than a ground voltage (GND).

A sustain signal (SUS) may be alternatively supplied to the first and second electrodes (Y, Z). The magnitude of the voltage of the sustain signal (SUS) may be ΔVs.

If the sustain signal (SUS) is supplied, the discharge cell selected by the address discharge generates a sustain discharge (i.e., display discharge) between the first electrode (Y) and the second electrode (Z), when the sustain signal (SUS) is supplied by adding the wall voltage within the discharge cell to the sustain voltage (ΔVs) of the sustain signal (SUS).

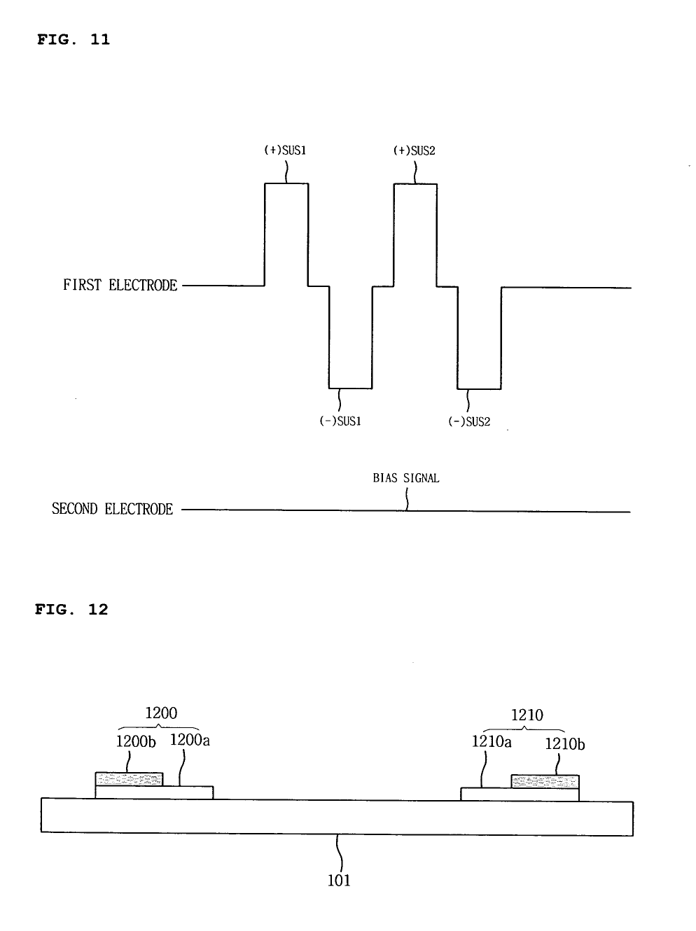

FIG. 11 is a diagram for explaining other type of a sustain signal.

Referring to FIG. 11, a positive (+) sustain signal and a negative (−) sustain signal are alternatively supplied to one of the first electrode (Y) and the second electrode (Z)

As such, if one (e.g., first electrode) of the first electrode (Y) and the second electrode (Z) is supplied with the positive (+) sustain signal and the negative (−) sustain signal, the other electrode (e.g., second electrode) can be supplied with a bias signal.

The bias signal can substantially and constantly maintain the voltage of the ground (GND).

As shown in FIG. 11, in a case where one of the first and second electrodes (Y, Z) is supplied with the sustain signal, there is a need for one driving board that circuits for supplying the sustain signal to one of the first and second electrodes (Y, Z) are arranged.

Consequently, a total size of a driver can be reduced, thereby allowing the manufacturing cost to be decreased.

FIG. 12 is a diagram for explaining a single layer structure of first and second electrodes in a structure that a discharge tip is omitted.

Referring to FIG. 12, it is exemplified that first and second electrodes 1200 and 1210 formed on the front substrate 101 is composed of a plurality of layers.

The first and second electrodes 1200 and 1210 include transparent electrodes 1200a and 1210a, and bus electrodes 1200b and 1210b.

As shown in FIG. 12, in a process of forming the first and second electrodes, the bus electrodes 1200b and 1210b are again formed after forming the transparent electrodes 1200a and 1210a.

Consequently, the number of the manufacturing process is increased by comparing to the case that the first and second electrodes are formed as single layer, thereby causing the manufacturing cost to be increased. Additionally, the manufacturing coat is more increased because of using

On the other hand, if the first and second electrodes are formed as single layer, the manufacturing process is simplified, and the manufacturing cost can be decreased because a material such as the expensive indium-tin-oxide (ITO) is not used.

Meanwhile, if the first and second electrodes are formed as single layer, a transparent material is not substantially used. Accordingly, the first and second electrodes may have a darker color than an upper dielectric layer that is formed on a front substrate, thereby allowing an open rate to be lowered. If the width of each of the first and second electrodes is reduced to increase the open rate, the discharge voltage is increased, thereby allowing the driving effect to be decreased.

As described above, according to the present invention, the distribution of the discharge gas is uniformed within the panel, and thus the discharge voltage is lowered. Accordingly, even when the first and second electrodes are formed as the single layer and the width of each of the first and second electrodes is reduced, the rapid increase of the discharge voltage can be prevented. Consequently, the manufacturing cost is reduced, as well as the decrease of the open rate and the driving effect can be prevented.

The first and second electrodes of the single layer structure may include a metal material that is opaque and electrical conductive material. For example the metal material such as Ag, Cu, Al, and other, has excellent electrical conduction, and is inexpensive in comparison with the indium-tin-oxide (ITO).

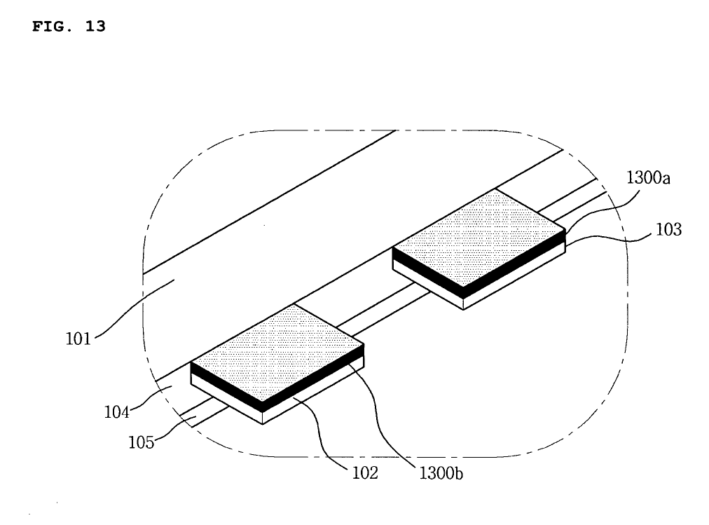

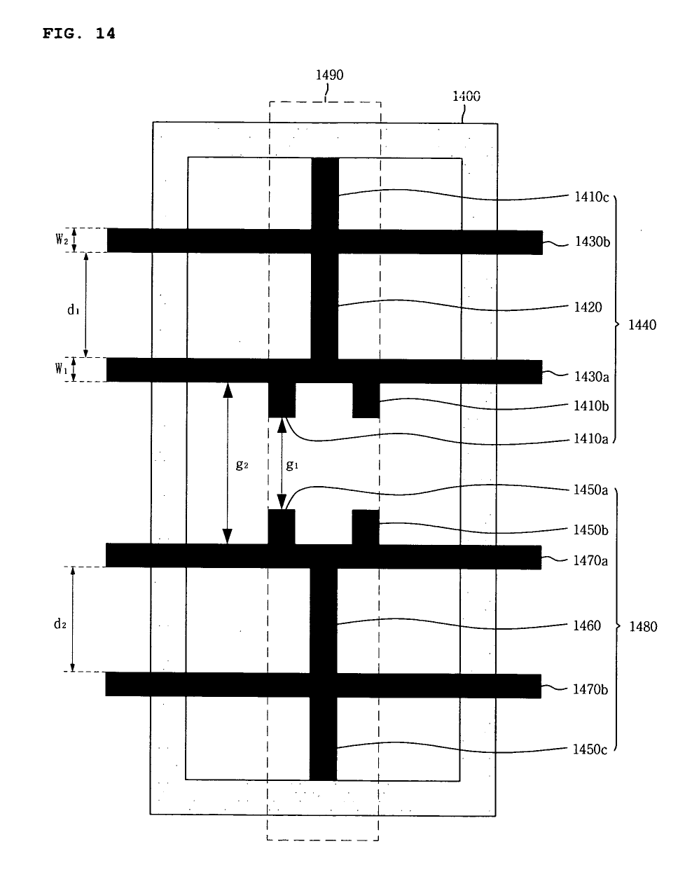

FIG. 13 is a diagram for explaining an example of a structure that a black layer is added between the first and second electrodes and a front substrate.

Referring to FIG. 13, black layers 1300a and 1300b are added between a front substrate 101 and the first and second electrodes 102 and 103. The black layers 1300a and 1300b prevent a color of the front substrate 101 from be changed and have a darker color than one of the first and second electrodes 102 and 103. In other words, if the front substrate 101 is directly in contact with the first electrode 102 or the second electrode 103, a desired region of the front substrate 101 can cause migration that is changed into a yellow color. The discolor of the front substrate 101 can be prevented by preventing the migration.

The black layers 1300a and 1300b may include a black material having a color of substantially dark series, for example, ruthenium (Rb).

If the black layers 1300a and 1300b are added between the front substrate 101 and the first and second electrodes 102 and 103, the generation of a reflected light can be prevented even when the first and second electrodes 102 and 103 are composed of a material having high reflectivity.

FIG. 14 is a diagram for explaining an example of the first and second electrodes of the plasma display panel according to the exemplary embodiment of the present invention.

Referring to FIG. 14, the first and second electrodes 1440 and 1480 may include one or more lines 1430a, 1430b, 1470a and 1470b.

The lines 1430a, 1430b, 1470a and 1470b are formed so as to intersect with a third electrode 1490 within the discharge cell divided by the barrier rib.

The lines 1430a, 1430b, 1470a and 1470b may be spaced by a specific distance to each other within the discharge cell.

For example, the first and second lines 1430a and 1430b of the first electrode 1440 are spaced by a distance (d1). The first and second lines 1470a and 1470b of the second electrode 1480 are spaced by a distance (d2). The distance (d1, d2) are the same, or different from each other.

Two or more lines can be aligned to be adjacent to each other.

The lines 1430a, 1430b, 1470a and 1470b have a specific width.

For example, the first line 1430a of the first electrode 1440 may have a width (W1), and the second line 1430b may have a width (W2), where W1 and W2 are the same or different from each other.

A shape of each of the first and second electrodes 1440 and 1480 may be symmetry to each other within the discharge cell.

The first and second electrodes 1440 and 1480 may include one or more protrusions 1410a, 1410b, 1410c, 1450a, 1450b and 1450c.

The protrusions 1410a, 1410b, 1410c, 1450a, 1450b and 1450c are protruded from the lines 1430a, 1430b, 1470a and 1470b. For example, first protrusions 1410a and 1410b of the first electrode 1440 are protruded from the first line 1420a, and a second protrusion 1410c is protruded from the second line 1430b.

A distance (g1) between the first electrode 1440 and the second electrode 1480 is shorter than a distance (g2). The term “distance (g1)” means a distance between the first electrode 1440 and the second electrode 1480 that are located on a part where the protrusions 1410a, 1410b, 1410c, 1450a, 1450b and 1450c are formed. The term “distance (g2)” means a distance between the first electrode 1440 and the second electrode 1480 that are located on a part where the protrusions 1410a, 1410b, 1410c, 1450a, 1450b and 1450c are not formed. Consequently, a start voltage occurring between the first and second electrodes 1440 and 1480, i.e., the discharge voltage can be lowered.

The protrusions 1410a, 1410b, 1410c, 1450a, 1450b and 1450c may be overlapped with the third electrode 1490 within the discharge cell. As a result thereof, the discharge voltage between the first and third electrodes 1440 and 1490 and between the second and third electrodes 1480 and 1490 can be lowered.

The first and second electrodes 1440 and 1480 may include connecting parts 1420 and 1460 that connect two or more lines 1430a, 1430b, 1470a and 1470b.

For example, in the first electrode 1440, the first line 1430a is connected to the second line 1430b via the connecting part 1420. In the second electrode 1480, the first line 1470a is connected to the second line 1470b via the connecting part 1460.

The connecting parts 1420 and 1460 enable the discharge to be uniformly spread all over the discharge cell.

The embodiments of the present invention have been described for illustrative purposes, and those skilled in the art will appreciate that various modifications, additions and substitutions are possible without departing from the scope of the present invention should be defined by the appended claims and their legal equivalents.

What is claimed is:

1. A plasma display apparatus, comprising:
a plasma display panel comprising a plurality of electrodes; and
a driver supplying a driving signal to a predetermined electrode of the plurality of electrodes,
wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, and
wherein a exhaust unit is omitted from the rear substrate, and the driver supplies a first reset signal to the first electrode in a reset period of a first subfield and supplies a second reset signal to the first electrode in the reset period of a second subfield,
wherein a magnitude of a voltage of the second reset signal is different from a magnitude of the voltage of the first reset signal of the first subfield.

2. The plasma display apparatus of claim 1, wherein a seal layer for sealing the front substrate and the rear substrate, is formed between the front substrate and rear substrate, and the seal layer comprises a photo-hardenable material.

3. The plasma display apparatus of claim 2, wherein the photo-hardenable material comprise epoxy.

4. The plasma display apparatus of claim 1, wherein the barrier rib comprises first and second barriers that intersect with each other, and the height of the first barrier rib is different from the height of the second barrier rib.

5. The plasma display apparatus of claim 1, wherein the discharge cell comprises first and second discharge cells, where a first phosphor layer is formed in the first discharge cell and a second phosphor layer is formed in the second discharge cell to emit light of a color different from the first phosphor layer, and the thickness of the first phosphor layer is different from the thickness of the second phosphor layer.

6. The plasma display apparatus of claim 1, wherein the first electrode and second electrodes are a single layer.

7. The plasma display apparatus of claim 1, wherein the first and second electrodes are an ITO-Less electrode that omits a transparent electrode.

8. The plasma display apparatus of claim 1, wherein gray scale weight of the first subfield is smaller than the gray scale weight of the second subfield, and the magnitude of a voltage of the first reset signal is greater than the magnitude of the voltage of the second reset signal.

9. The plasma display apparatus of claim 1, wherein the first subfield is aligned on the earliest time among the plurality of the subfields.

10. A plasma display apparatus, comprising:
a plasma display panel comprising a plurality of electrodes; and
a driver supplying a driving signal to a predetermined electrode of the plurality of electrodes,
wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates, and
wherein a exhaust unit is omitted from the rear substrate, and the driver supplies one or more first reset signals to the first electrode in a reset period of a first subfield and supplies one or more second reset signals to the first electrode in the reset period of a second subfield,
wherein a number of the first reset signals are different from a number of the second reset signals.

11. The plasma display apparatus of claim 10, wherein a seal layer is formed between the front substrate and rear substrate to seal them to each other, and the seal layer comprises a photo-hardenable material.

12. The plasma display apparatus of claim 11, wherein the photo-hardenable material comprise epoxy.

13. The plasma display apparatus of claim 10, wherein the barrier rib comprises first and second barriers that intersect with each other, and the height of the first barrier rib is different from the height of the second barrier rib.

14. The plasma display apparatus of claim 10, wherein the discharge cell comprises first and second discharge cells, where a first phosphor layer is formed in the first discharge cell and a second phosphor layer is formed in the second discharge cell to emit light of a color different from the first phosphor, and the thickness of the first phosphor layer is different from the thickness of the second phosphor layer.

15. The plasma display apparatus of claim 10, wherein the first and second electrodes are formed as a single layer.

16. The plasma display apparatus of claim 10, wherein the first and second electrodes are an ITO-Less electrode where a transparent electrode is omitted.

17. The plasma display apparatus of claim 10, wherein gray scale weight of the first subfield is smaller than the gray scale weight of the second subfield, and a voltage of the first reset signal is higher than the voltage of the second reset signal.

18. A plasma display apparatus, comprising:
a plasma display panel comprising a plurality of electrodes; and
a driver supplying a driving signal to a predetermined electrode of the plurality of electrodes,
wherein the plasma display panel comprises a front substrate on which first and second electrodes are formed in parallel to each other, a rear substrate aligned in opposite to the front substrate and forming a third electrode where the first and second electrodes intersect, and a barrier rib partitioning the discharge cell between the front and rear substrates,
wherein a exhaust unit is omitted from the rear substrate, and the driver supplies a reset signal to the first electrode in a reset period of a first subfield, and
wherein the driver does not supply the reset signal to the first electrode in a reset period of a second subfield, or omits the reset period of the second subfield.

19. The plasma display apparatus of claim 18, wherein gray scale weight of the first subfield is smaller than gray scale weight of the second subfield.

20. The plasma display apparatus of claim 18, wherein the first subfield is aligned on the earliest time among the plurality of the subfields.
